(19) United States
(12) Patent Application Publication
(10) Pub. No.: US 2004/0138968 A1
(43) Pub. Date: Jul. 15, 2004

(54) Purchase card performance system

(75) Inventor: Terence M. Carr, Cincinnati, OH (US)

Correspondence Address: FROST BROWN TODD LLC, 2200 PNC Center, 201 E. Fifth Street, Cincinnati, OH, 45202-4182, US

(73) Assignee: RINA Systems, Inc.

(21) Appl. No.: 10/340,296

(22) Filed: Jan. 10, 2003

(51) Int. Cl. G06F 17/60

(52) U.S. Cl. 705/30

(57) ABSTRACT

A Purchase Card Maximization apparatus, method, and program product enhances efficiencies realized by an organization through (1) Performance Metrics And Reporting by analyzing applicable purchases through a cost center hierarchical display, measuring performance against baseline targets, highlighting areas in need of improvement, and providing reports that list specific steps to improve purchase card program performance; (2) Usage Compliance by applying specific company policy regulations to current purchase card transactions, record and track violations of company policies by cardholders and organization, automatically providing email notification of violations to cardholders, and providing escalation policy for dealing with repeat offenders; and (3) Audit Implementation And Tracking by applying a specific company policy to determine cardholders to be audited, recording and tracking results of cardholder audits, ensuring due diligence in applying audit strategy, and reporting overall program compliance through audit reporting.

### FIELD OF THE INVENTION

This invention relates to a system and method for monitoring organizational use of an adjudicated third party payment at the point of service (e.g., purchase card) in lieu of more elaborate procurement channels, and more particularly, to a system and method for analyzing performance metrics, usage compliance, and audit implementation and tracking for organizational purchase card programs.

### BACKGROUND OF THE INVENTION

Private and governmental institutions (“sponsors”) are increasingly turning to purchase card programs that are accepted by vendors in the same manner as credit cards. Purchase cards have the advantage of quickly effecting the transfer of funds and lend themselves to use in person, over the Internet, faxed order forms, and telephone orders. The purchase card transaction is greatly simplified over traditional procurement transactions requiring a purchase order, invoice, and payment or similar procedure.

Vendors throughout the world accept purchase card without question because they are familiar with commercial credit cards and they understand how to accept them. The account holders of a purchase card benefit by being able to decide what to purchase, when to buy it, and from whom, and can monitor funds availability. The sponsor of the account holders benefits by saving time, money and resources, especially for low dollar value, high-volume procurements made with purchase cards.

Accountability for usage of the purchase card is often managed by the third-party facilitator that issues the purchase cards and mediates the transactions between vendors and sponsors that use the purchase cards. For instance, the purchase card is often not a revolving credit card, but rather works as a debit card with a dollar amount fixed to the card, which is reduced by the amount of each purchase. If the cost of the item exceeds the balance on the card, the transaction cannot be completed. There may also be restrictions on the use of the purchase card, which reflect the account's budget and the sponsor's restrictions, if any. The third-party facilitators for purchase accounts also provide transaction summaries that are also useful for the organizations to review and audit to avoid misuse of the purchase cards.

Much development has occurred in the handling of credit card and purchase card transactions. Purchasing Card (“PCard”) programs have provided documented gains in productivity and effectiveness for organizations that utilize them. Implementing a Purchasing Card program in an organization, however, can be a difficult task for the administrator as it deals with change in many areas of the business where the administrator has no control. The sponsors often have inadequate insight into the use of the purchase card with regard to traditional procurement channels, especially when seeking to identify groups or individuals that are under- or over-utilizing their purchase card.

Consequently, a significant need exists for an approach for giving a sponsor organization insight into the use of their purchase accounts in order to optimize the economic savings thereof.

### BRIEF SUMMARY OF THE INVENTION

The invention overcomes the above-noted and other deficiencies of the prior art by providing a Purchase Card Maximization method, apparatus, and program product that interactively analyzes purchasing decisions made during the period in analysis, thereby evaluating the efficiency of a purchasing function of an organization and identifying areas for improvement, and also advantageously performing auditing and compliance verification functions.

In one aspect of the invention, a purchase account transactions of an organization having a plurality of account holders authorized to perform purchase account transactions and traditional procurement transactions are analyzed to determine a value of traditional procurement transactions, to determine a value of purchase account transactions, and to calculate a performance measure based on the values of the traditional procurement transactions and purchase account transactions. Thereby, a clear metric may be applied to cardholders and cost centers of an organization to better manage use of purchase accounts.

In another aspect of the invention, a method is described that includes associating account holder records to one of a number of hierarchically related cost centers, receiving purchase account transactions and traditional procurement transactions for the account holders and calculating a performance measure for each cost center based on the assigned values of the traditional procurement transactions and purchase account transactions. Thereby, the typical hierarchical nature of an organization and the large number of account holders are handled in a way that is meaningful for analysis.

These and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a diagram of a hardware environment of an enterprise system for procurement and accounting processing having a purchase card maximization capability.

FIG. 2 is a diagram of a software environment of the purchase card maximizer of FIG. 1.

FIG. 3 is an object oriented language class diagram for the data structures used by the purchase card maximizer of FIGS. 1 and 2 for uploading transaction data.

FIG. 4 is an object oriented language class diagram for the data structures used by the purchase card maximizer of FIGS. 1 and 2 for report creation.

FIG. 5 is an object oriented language class diagram for the data structures used by the purchase card maximizer of FIGS. 1 and 2 for generating a on account holder (cardholder) activities.

FIG. 6 is an object oriented language class diagram for the data structures used by the purchase card maximizer of FIGS. 1 and 2 for data processing and report preparation.

FIG. 7 is an object oriented language class diagram for the data structures used by the purchase card maximizer of FIGS. 1 and 2 for supporting data.

FIG. 8 is a sequence of operation of the purchase card maximizer of FIGS. 1 and 2 for analyzing performance metrics, usage compliance, and audit implementation and tracking for organizational purchase card programs.

FIG. 9 is a diagram depiction of a user interface to the purchase card maximizer of FIGS. 1 and 2 for configuration management.

FIG. 10 is a diagram depiction of a user interface to the purchase card maximizer of FIGS. 1 and 2 for data processing.

FIG. 11 is a diagram depiction of a user interface to the purchase card maximizer of FIGS. 1 and 2 for the end-of-cycle tasks of entering audit results.

FIG. 12 is a diagram depiction of a user interface to the purchase card maximizer of FIGS. 1 and 2 for the reporting task of analyzing performance by cost center.

FIG. 13 is a diagram depiction of a user interface to the purchase card maximizer of FIGS. 1 and 2 for the reporting task of analyzing potential vendors for purchasing card use.

### DETAILED DESCRIPTION OF THE INVENTION

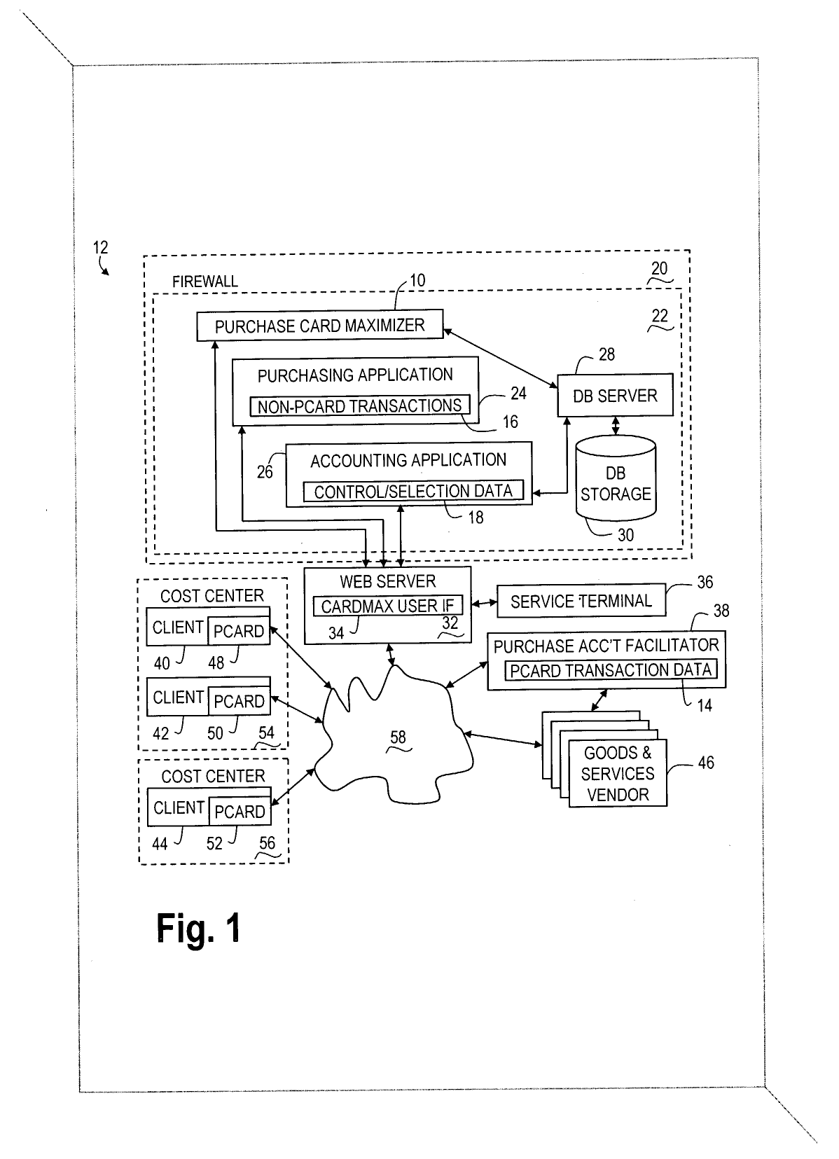

In FIG. 1, a purchase card maximization system 10 (“CardMax system”) is to provide an easy to use, standardized method to measure and report the performance of a purchasing card (“PCard”) operation within in enterprise network 12. Through the use of common web-based technologies, it measures the purchases of an organization to determine the percentages of applicable purchases made on the PCard versus those made through other means. By doing this, the CardMax system 10 is able to show not only the purchases that were made on the PCard, but also, the missed opportunity of purchases that could have been made on the PCard, by parts of an organization, types of purchases, and specific vendor candidates.

There are three primary sources of data for the CardMax system 10. PCard Purchasing Data (“PCard Transaction Data”) 14 that provides a list of purchases made during a specific period. Generally the PCard transaction data 14 includes the date of purchase, the vendor, the amount and the identifying codes (e.g. Cost center) used by the organization. The second source of data is General Ledger (GL) Accounting Data, or “non-PCard transaction data” 16, that provides a list of expenses logged during a specific period that includes the date of expense, the vendor, the amount and identifying information about the expense. The third source of data is Control/Selection Data 18 that provides a list of codes that should be accepted as valid categories of expenses and lists of cost centers and cardholders by which to group transactions. The GL Accounting Data 16 may include many types of expenses that may not be applicable to PCard purchases, which may be filtered by the control/selection data 18 so that only applicable expenses are included and analyzed.

The enterprise network 12 is illustrative of an organization having a segregated procurement and accounting system 20 that includes a firewall-protected portion 22. The non-PCard transaction data 16 resides in the firewall-protected portion 22 upon a purchasing application 24 used for procurement actions. The control/selection data 18 resides within an accounting application 26 that is also within the firewall protected portion 22. The purchase card maximizer 10 also resides within the firewall-protected portion 22. Each of the applications 10, 20, 26 interface to a database (DB) server 28 and hence to a DB storage medium 30, both of latter also residing in the firewall protected portion 22.

The illustrative depiction of FIG. 1 depicts a decentralized architecture wherein the procurement and accounting system 20 is interfaced to an external web server 32, which includes a CardMax user interface (IF) 34. A customer interfaces to the CardMax user interface 34 via a service terminal 36 in order to perform function such as uploading the purchase card transaction data 14 from a purchase account facilitator 38 (e.g., a financial institution). The purchase account facilitator 38 mediates and tracks purchases made by a plurality of account holders (“client”) 40-44 with a number of vendors 46 that provide goods and services. Each account holder 40-44 has a respective purchase account (“PCard”) 48-52. Within the organization, the account holders 40-44 may be advantageously grouped into Cost Centers 54, 56, enabling analysis of management and efficiency of various subgroups.

The interactions between account holders 40-44, vendors 46, the customer service terminal 36, and the web server 32 are depicted as passing through a communication network 58, which may include or comprise in its entirety one or more of a digital network (e.g., Internet), telephone network, wireless network, local area network, wide area network, and other means apparent to those skilled in the art having benefit of the present disclosure.

The customer (e.g., CardMax administrator) is able to configure the purchase card maximizer 10 through the service terminal 36, such as selecting data formats, excluding certain vendors from analysis, creation of certain data extracts. The CardMax administrator is also able to generate performance reports for a given time frame, showing by demographic group the amount and number of purchases made through the purchasing card and those made through other means. They will make it easy to highlight areas of the organization that are effectively using the purchasing card and those that have opportunity for improvement. The CardMax administrator is also able to generate improvement reports for an area of the organization, specifying actions that can be made in the future to improve PCard performance. It will also be appreciated that comparisons may be made between different organizations for benchmarking purposes. This capability enables comparisons by demographics, such as type of industry or length of time the PCard program has been implemented.

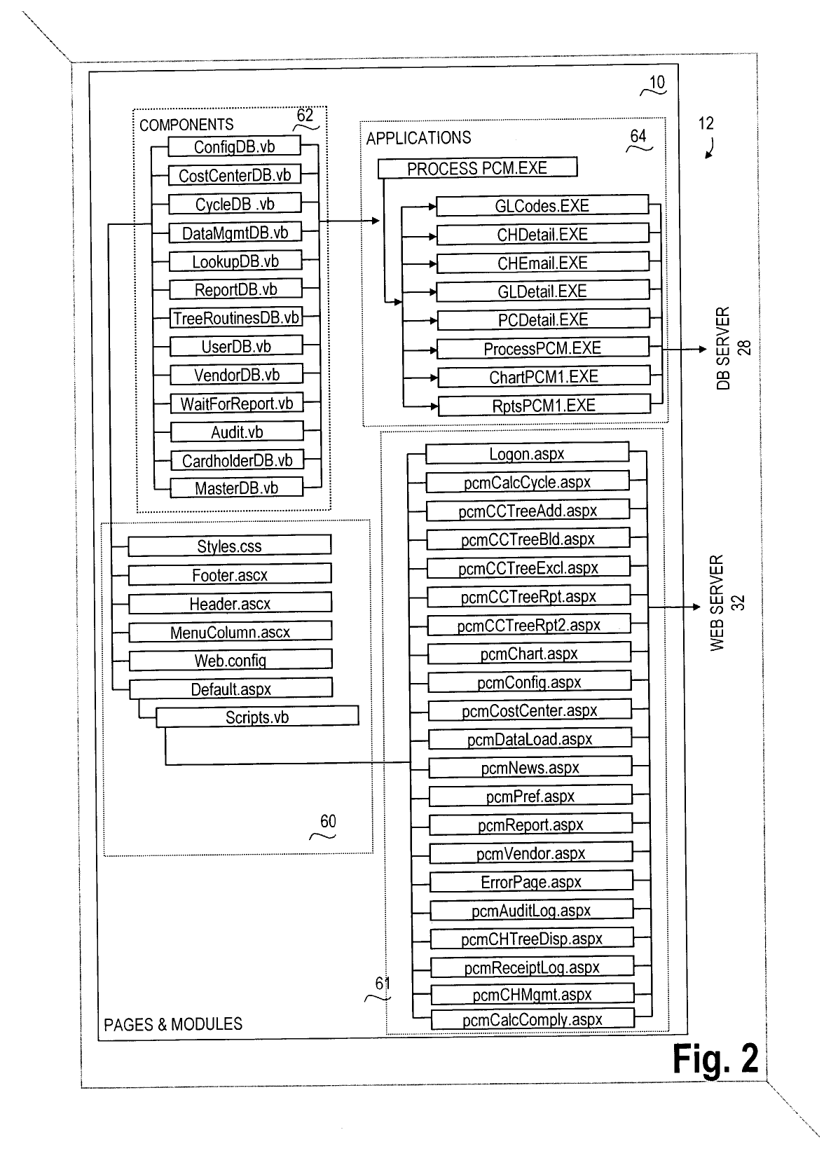

In FIG. 2, an exemplary “.Net” implementation is depicted for the purchase card maximizer 10, including pages and modules 60 that interface to the web server 32, components 62 coupled to the pages and modules 60, and applications 64 coupled to the components 62 and to the DB server 28.

The pages and modules 60 and 61 include hypertext pages implemented in ASP+ (also called ASP.NET), which is the next generation of Microsoft's Active Server Page (ASP), a feature of their Internet Information Server (IIS). Both ASP and ASP+allow a Web site builder to dynamically build Web pages on the fly by inserting queries to a relational database in the Web page. ASP+ is different than its predecessor in two major ways: it supports code written in compiled languages such as Visual Basic, C++, C#, and Perl, and it features server controls that can separate the code from the content, allowing WYSIWYG editing of pages. Although ASP+ is not backward compatible with ASP, it is able to run side by side with ASP applications. ASP+ files can be recognized by their .aspx extension. The pages and modules 60 include a Web.config ASP.NET configuration file that contains configuration data on each unique URL resource used in the project.

A Default.aspx page is a welcome page with the short description of the tools and methodology to analyze the performance of the purchase card program. Interface controls are accessed from the Default.aspx page, specifically Scripts.vb, a simple data class that contains support functionality for the user interface, and a Styles.css Styles Class that contains information used for support the style of the user interface. A Footer.ascx User control is used to display copyright line at the bottom of all Web pages. A Header.ascx User control is used to display header information at the top of all Web pages. This control is also responsible for creating submenu information corresponding to each Web page. A MenuColumn.ascx User control is used to display menu information.

The scripts.vb data class in turn accesses a number of sub-pages: A Logon.aspx Page Class is used to authenticate a customer's supplied User name/password credentials against a database. A pcmCalcCycle.aspx Page Class is used to calculate purchase card performance for the chosen cycle. A pcmCCTreeAdd.aspx Page Class is used to add a new Cost Center to the Cost Center Hierarchy. A pcmCCTreeBld.aspx Page Class is used to set a Cost Center Hierarchical display. A pcmCCTreeExcl.aspx Page Class is used to exclude Cost Centers that are not participating in the purchase card program for the cycle. A pcmCCTreeRpt.aspx Page Class is used to display Cost Center performance by analyzing applicable purchases through a Cost Center Hierarchy. A pcmCCTreeRpt2.aspx Page Class is used to display and compare Cost Center performance for the two different cycles. A pcmChart.aspx Page Class is used to display purchase card performance charts for the chosen Cost Center from a Cost Center hierarchy. A pcmConfig.aspx Page Class is used to give user ability display and change configuration parameters, add new cycle and update existing cycle. pcmCostCenter.aspx Page Class is used to display filtered Cost Center list in order to update it. A pcmDataLoad.aspx Page Class is used to perform initial data load, load list of Valid GL Codes, load GL data for Cycle, load purchase card transactions data for Cycle. A pcmNews.aspx Page class is used to provide current news of interest to CardMax administrators. A pcmPref.aspx Page class provides controls for modifying the use interface. A pcmReport.aspx Page Class is used to display newly created purchase card reports or load existing reports. A pcmVendor.aspx Page Class is used to display filtered Vendor list in order to exclude/include vendors from/into purchase card program. An ErrorPage.aspx Page Class is used to return to the user information that invalid event has occurred. A pcmAuditLog.aspx Page Class is used to display filtered Cardholder list in order to analyze Cardholder's activity within predetermined Cycle period. A pcmCHTreeDisp.aspx Page Class is used to display Cardholder's activity through a Cost Center Hierarchy within predetermined Cycle period. A pcmReceiptLog.aspx Page Class is used to display filtered Cardholder list in order to obtain Logged/Non-Logged Receipts information. A pcmCHMgmt.aspx Page Class is used to manage and assign Cardholder information. A pcmCalcComply.aspx Page Class is used to calculate compliance measurements for a cycle.

The components 62 are implemented in Visual Basic (VB), which is a programming environment from Microsoft in which a programmer uses a graphical user interface to choose and modify preselected sections of code written in the BASIC programming language. A ConfigDB.vb Business/Data Logic Class encapsulates all data logic necessary to update/query Config table within the Purchase Card Maximizer (PCM) database in DB storage 30. A CostCenterDB.vb Business/Data Logic Class encapsulates all data logic necessary to add/update/query Cost Center Management tables within the PCM database. A CycleDB.vb-Business/Data Logic Class encapsulates all data logic necessary to add/query Cycle Management tables within the PCM database to generate cycle results. A DataMgmtDB.vb Business/Data Logic Class encapsulates all data logic necessary to add/update/query Data Management tables within the PCM database. A LookupDB.vb Business/Data Logic Class encapsulates all data logic necessary to add/update/query Lookup tables within the PCM database. A ReportDB.vb Report Logic Class encapsulates all data logic necessary to add/update/query Report tables within the PCM database. A TreeRoutinesDB.vb Business/Data Logic Class encapsulates all data logic necessary to create Cost Center Hierarchical display. A UserDB.vb simple data class encapsulates details about a particular PCM User. A VendorDB.vb Business/Data Logic Class encapsulates all data logic necessary to update/query Vendor tables within the PCM database. A WaitForReport.vb class module checks report status in order to display the report in needed format. An Audit.vb Business/Data Logic Class encapsulates all data logic necessary to perform analysis of the activity of groups of cardholders within predetermined cycle period. A CardholderDB.vb Business/Data Logic Class encapsulates all data logic necessary to analyze the information about cardholder's activity. A MasterDB.vb Business/Data Logic Class encapsulates all data logic necessary to navigate a user to their specific instance of the CardMax database. The applications 64 include programs that effect the preparation of the analyses. A GLCodes.exe application loads a list of valid GL Codes into the PCM database. A CHDetail.exe application loads Cardholder Data into the PCM database. A CHEmail.exe application loads Cardholder Email Addresses into the PCM database. A GLDetail.exe application loads GL Data for the cycle into the PCM database. A PCDetail.exe application loads purchase card transaction data for the cycle into the PCM database. A ProcessPCM.exe application detects and executes any request from the user to load data into the PCM database, to create reports, or to create charts. A ChartPCM1.exe application creates purchase card performance charts and stores them in the PCM database in JPG format. A RptsPCM1.exe application creates purchase card performance reports and store them in the PCM database in PDF format.

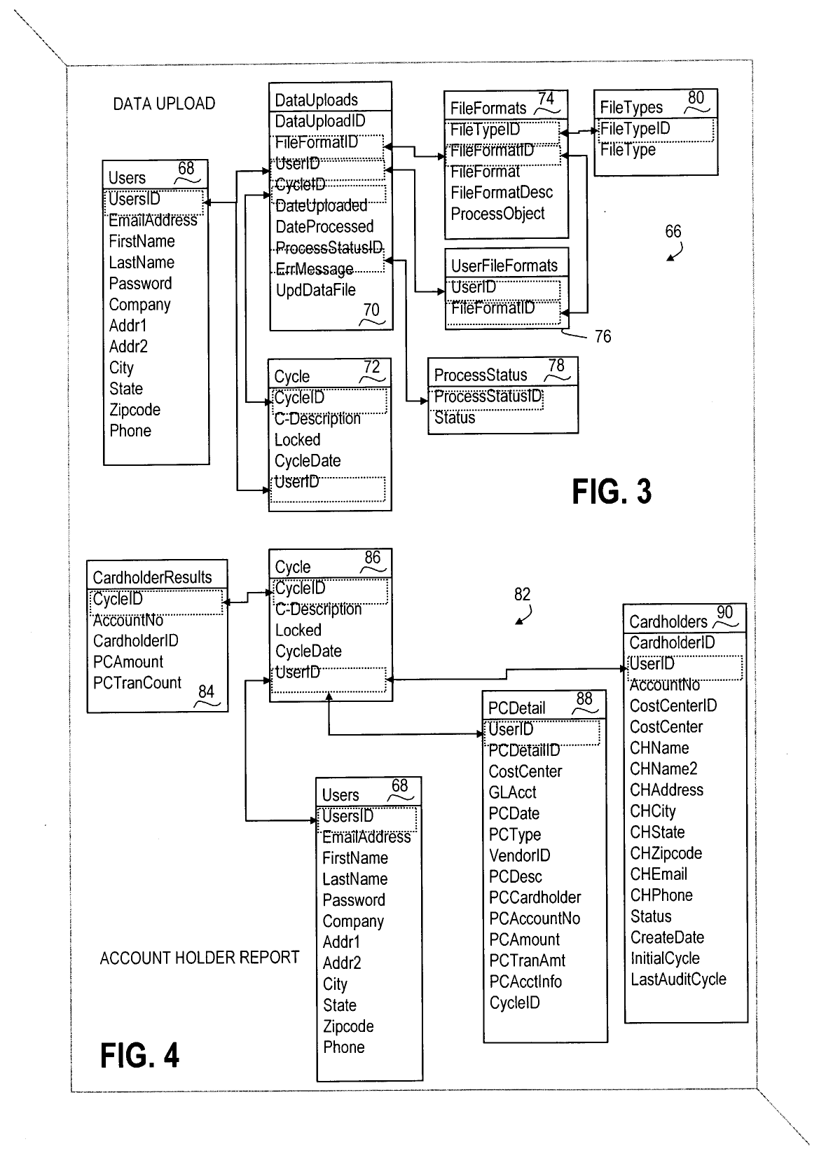

FIGS. 3-7 depict relationships between tables and fields used respectively to upload purchase account transactions, prepare account holder reports, create a report, to support company specific interfaces and preferences, and data processing and report preparation. In FIG. 4, a data download capability 66 includes a Users table 68 (having fields UsersID, EmailAddress, FirstName, LastName, Password, Company, Addr1, Addr2, City, State, Zipcode, and Phone) that is linked via key field UserID to DataUploads table 70 (having fields DataUploadID, FileFormatID, UserID, CycleID, DateUploaded, DateProcessed, ProcessStatusID, ErrMessage, and UpdDataFile). The Users table 68 is linked via key field UserID and DataUploads table 70 is linked via key field CycleID to a Cycle table 72 (having fields CycleID, C-Description, Locked, CycleDate, and UserID). The DataUploads table 70 is linked via key field FileFormatID to a FileFormats table 74 (having fields FileTypeID, FileFormatID, FileFormat, FileFormatDesc, and ProcessObject). The DataUploads table 70 is linked via key field UserID to a UserFileFormats table 76 (having fields UserID and FileFormatID). The DataUploads table 70 is linked via key field CycleID to a ProcessStatus table 78 (having fields ProcessStatusID and Status). The FileFormats table 74 is linked via key field FileTypeID to a FileTypes table 80 (having fields FileTypeID and FileType).

In FIG. 4, an account holder report capability 82 includes a CardholderResults table 84 (having fields CycleID, AccountNo, CardholderID, PCAmount, and PCTranCount) is linked via key field CycleID to a Cycle table 86 (having fields CycleID, C-Description, Locked, CycleDate, and UserID). The Cycle table 84 is linked via key field UserID to the Users table 68, to a PCDetail table 88 (having fields UserID, PCDetailID, CostCenter, GLAcct, PCDate, PCType, VendorID, PCDesc, PCCardholder, PCAccountNo, PCAmount, PCTranAmt, PCAcctInfo, and CycleID), and to a Cardholders table 90 (having fields UserID, AccountNo, CostCenterID, CostCenter, CHName, CHName2, CHAddress, CHCity, CHState, CHZipcode, CHEmail, CHPhone, Status, CreateDate, InitialCycle, and LastAuditCycle).

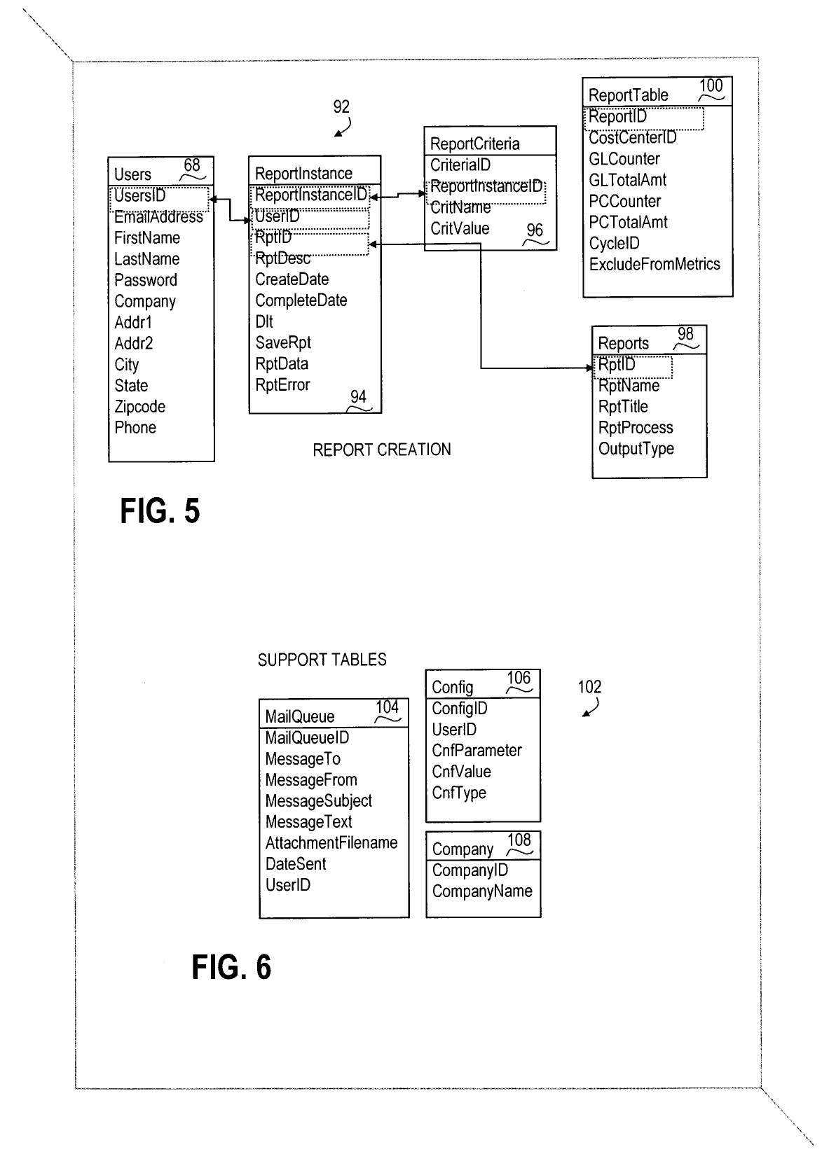

In FIG. 5, a report creation capability 92 is achieved by linking the Users table 68 via key field UserID to a ReportInstance Table 94 (having fields ReportInstanceID, UserID, RptID, RptDesc, CreateDate, CompleteDate, Dlt, SaveRpt, RptData, RptError). The ReportInstance Table 94 is linked via keyfield ReportInstanceID to a ReportCriteria table 96 (having fields CriteriaID, ReportInstanceID, CritName, and CritValue). The ReportInstance table 94 is also linked via a keyfield RptID to both a Reports table 98 (having fields RptID, RptName, RptTitle, RptProcess, and OutputType) and to a ReportTable table 100 (having fields ReportID, CostCenterID, GLCounter, GLTotalAmt, PCCounter, PCTotalAmt, CycleID, and ExcludeFromMetrics).

In FIG. 6, a support table capability 102 includes a MailQueue table 104 (having fields MailQueueID, MessageTo, MessageFrom, MessageSubject, MessageText, AttachmentFilename, DateSent and UserID) for managing automail distribution of reports. A Config table 106 (having fields ConfigID, UserID, CnfParameter, CnfValue and CnfType) stores individual configurations for each CardMax administrator. A Company table 108 (having fields CompanyID and CompanyName) allows an installation of Cardmax system 10 to service multiple organizations.

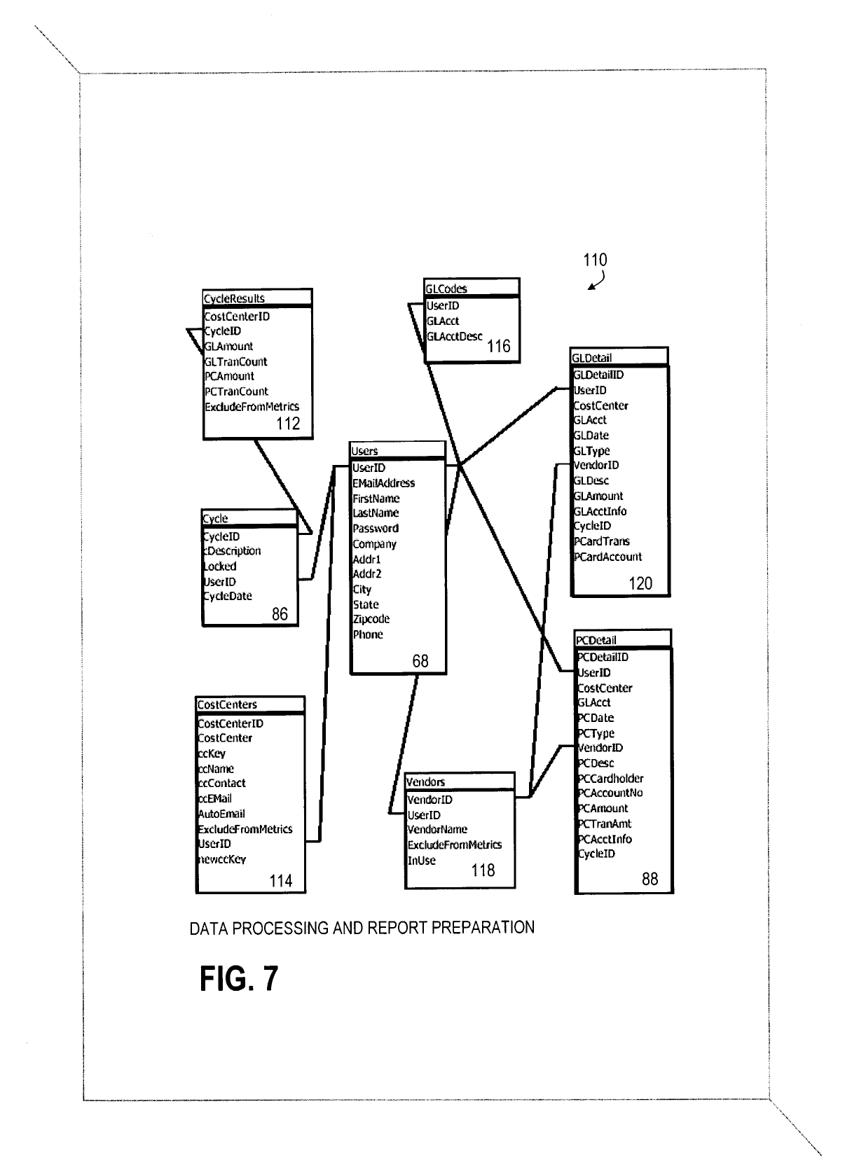

In FIG. 7, a data processing and report preparation capability 110 is depicted. The Users table 68 is linked via key field UserID to the Cycle table 86, which in turn is linked to a CycleResults table 112 (having fields CostCenterID, CycleID, GLAmount, GLTranCount, PCAmount, PCTranCount, and ExcludeFromMetrics). The Users table 68 is also linked to a CostCenters table 114 (having fields CostCenterID, CostCenter, ccKey, ccName, ccContact, ccEMail, AutoEmail, ExcludeFromMetrics, UserID, and newccKey), to a GLCodes table 116 (having fields UserID, GLAcct, and GLAcctDesc), to a Vendors table 118 (having fields VendorID, UserID, VendorName, ExcludeFromMetrics, and InUse), to the PCDetail table 88, and to a GLDetail table 120 (having fields GLDetailID, UserID, CostCenter, GLAcct, GLDate, GLType, VendorID, GLDesc, GLAmount, GLAcctInfo, CycleID, PCardTrans, and PCardAccount). The Vendors table 118, the GLDetail table 120, and the PCDetail table 88 are also linked to one another by key field VendorID.

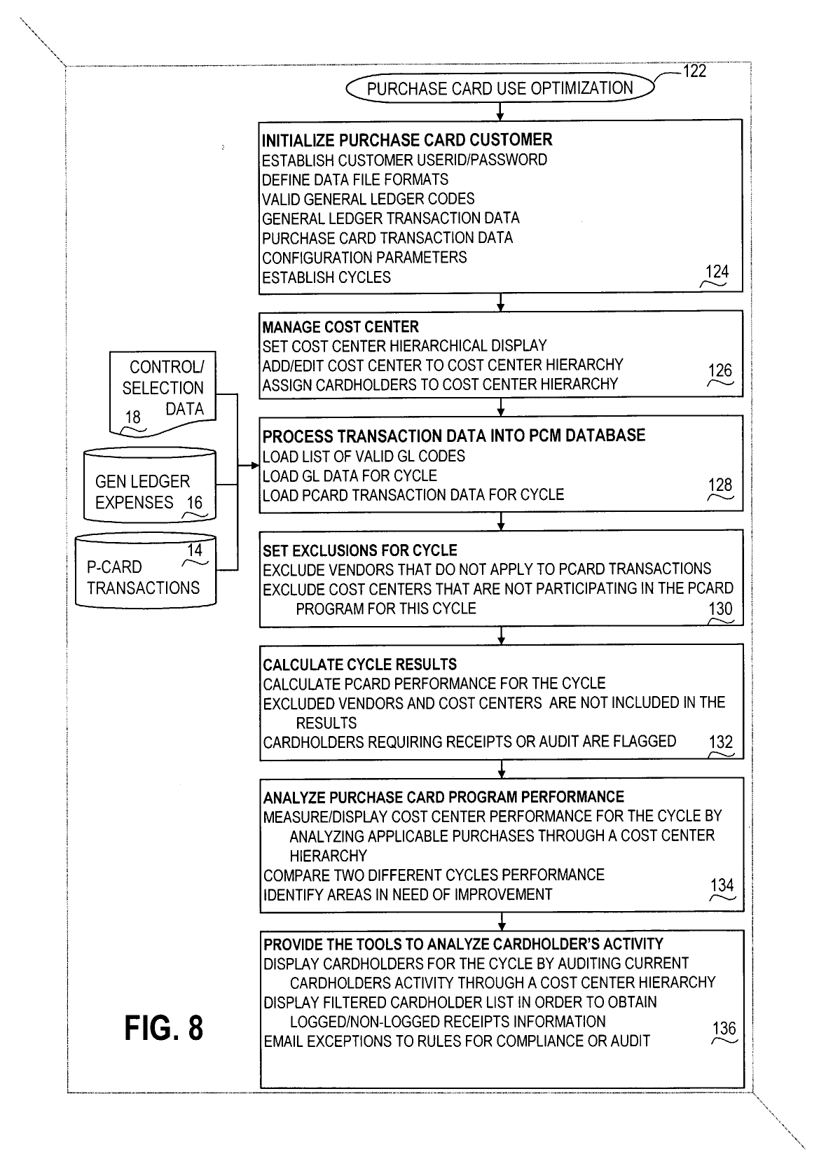

In FIG. 8, a sequence of operations, or procedure 122, is depicted for purchase account use optimization, an illustrative use of the PCard maximizer 10 of FIGS. 1-2 to analyze the use of purchase accounts. In block 124, the purchase card customer is initialized in the system, which advantageously includes establishing a customer user ID and password, defining a data file formats that is to be used in merging transaction data, identifying valid general ledger codes for the types of transactions to be analyzed, initializing storage locations for transaction data to be received (e.g., non-purchase account transactions, purchase account transactions), setting configuration parameters for the user interface, and establishing the analysis cycles.

In block 126, cost centers are managed, which includes setting a hierarchical representation or display (i.e., relationships between cost centers), and modifying individual costs centers (e.g., adding, editing, or deleting). It will be appreciated that purchase account holders are assigned to cost centers as part of initializing or editing their information.

In block 128, transaction data for the cycle to be processed and analyzed are uploaded into a PCM database. This uploading includes loading a list of valid general ledger (GL) codes from the control/selection data table 18. It also includes loading GL data (i.e., non-purchase account transactions) from the general ledger expenses database 16. It also includes loading purchase account transactions data for this cycle from the purchase account transactions database 14, which typically has been retrieved from a third party. In block 130, exclusions for the cycle are set, wherein cost centers or vendors that are not participating in participating in the purchase account operation are excluded in order to focus on transactions that are appropriate for analysis.

In block 132, purchase card performance of the organization for the cycle is calculated. The vendors that have been excluded are not included in the results. The cost centers that have been excluded are calculated, but are not included at reporting or charting time. With the amounts calculated, then in block 134, the purchase card program performance is analyzed. Advantageously, analyses may include measuring and displaying cost center performance for the cycle by analyzing applicable purchases through a cost center hierarchy, comparing performance across two different cycles, and highlighting areas of the organization in need of improvement.

In block 136, the cardholders' activity is analyzed, which advantageously may include displaying cardholders for the cycle by auditing current cardholders activity through a cost center hierarchy, and displaying filtered cardholder list in order to obtain Logged/Non-Logged Receipts information.

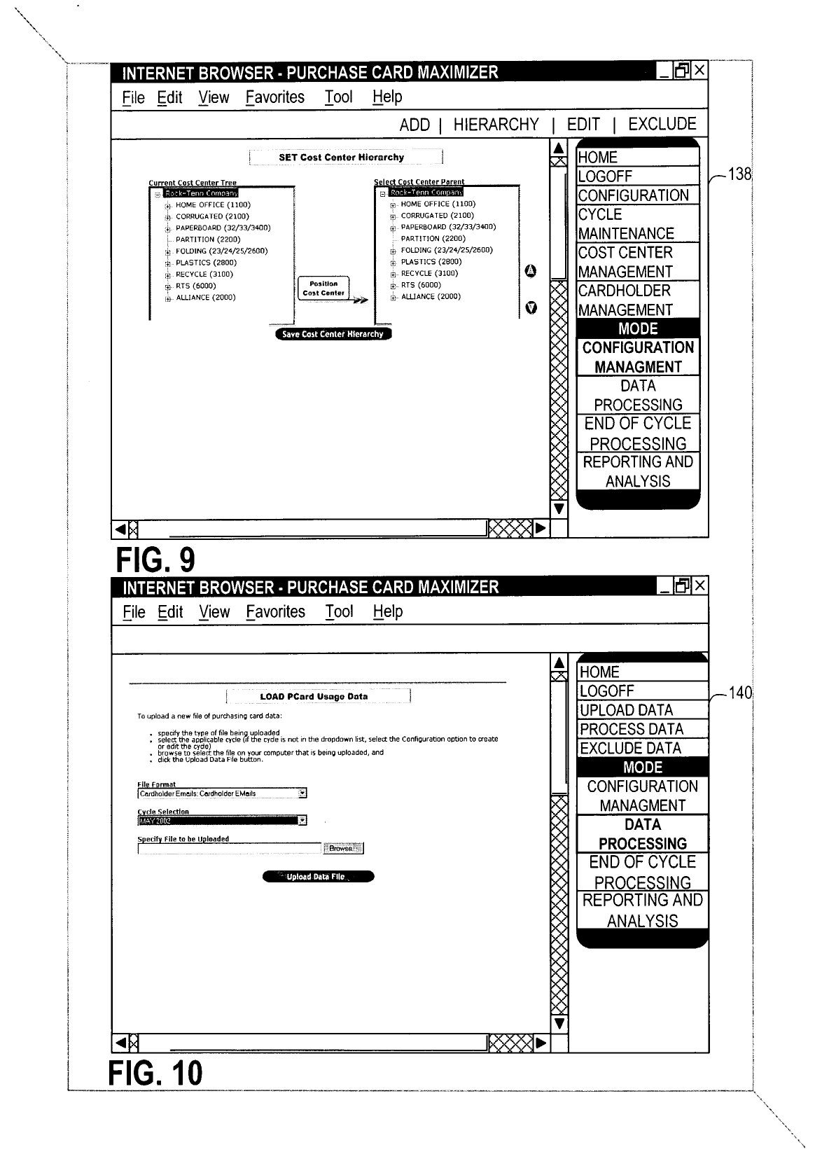

FIG. 9 depicts an illustrative graphical user interface (GUI) screen 138 for manually inserting such selections and information, although it will be appreciated that repetitive or default settings may be loaded for one or more new customers. The configuration management mode link 140 is selected on a mode task bar 142, which also includes a data processing, end-of-cycle processing, and reporting and analysis links 144-150. The sub-page selections on the mode task bar 142 are changed to reflect the mode selected. For configuration management mode, the sub-page selections are a home key 152, a logoff key 154, a configuration key 156, a cycle maintenance key 158, a cost center management key 160, and a cardholder management key 162. In the sub-page frame 164, an example of a graphical hierarchical representation is depicted of cost centers of an organization and an approach to cost center management (e.g., relating cost centers to one another).

The sub-page selections on the mode task bar 142 are changed to reflect the mode selected. For configuration management mode, the sub-page selections are a home key 152, a logoff key 154, a configuration key 156, a cycle maintenance key 158, a cost center management key 160, and a cardholder management key 162. In a sub-page frame 164, an example of a graphical cost center hierarchical representation 166, which is presented in response to selecting cost center management mode key 160, depicts cost centers of an organization and an approach to cost center management (e.g., relating cost centers to one another). Although not depicted, another interface is presented for each sub-page selection link. For instance, selection of the configuration link 156 would also entry or modification of parameters for use in the PCard maximizer: Audit Percent Per Cycle, Audit Score Count, Audit Score Labels, Cardholder Audit Tree Level, Legend Descriptions, Mandatory Audit Cycle, Maximum Cycles Without Audit, Metric Dollar Limit, Metric Low Limit, and Metric Warning Limit.

FIG. 10 depicts the GUI screen 138 wherein the data processing mode link 144 has been selected, which in turn displays a list of available sub-page selections on the task bar 142: the home link 152, the logoff link 154, an upload data link 168, a process data link 170, an exclude data link 172 and a calculate cycle performance link 174. The upload data link 168 has been selected, displaying a “Load PCard Usage Data” form 176 on the sub-page frame 164.

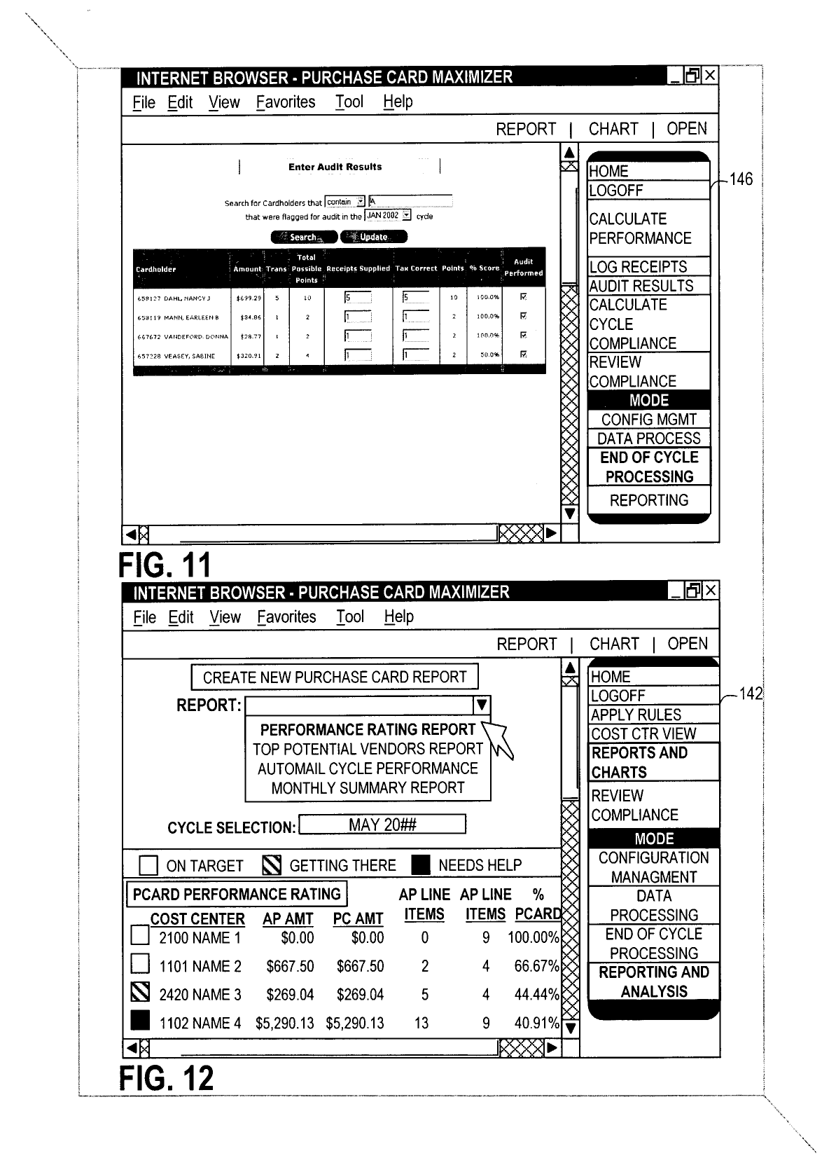

FIG. 11 depicts the GUI screen 138 wherein the recurring tasks mode link 146 has been selected, which in turn displays a list of available sub-page selections on the task bar 142: the home link 152, the logoff link 154, an apply rules link 178, a cost center view link 180, a reports and charts link 182, and a review compliance link 184. The selected reports and charts link 182 has in turn displayed a performance rating report 186 in the sub-page frame 164. Thereby, the cost centers are listed with the totaled amounts of all purchases (“AP AMT”), amounts of all purchase card transactions (“PC AMT”), the number of line items of AP transactions, the number of line items of PC transactions, and a percentage calculation of the PCard transactions as compared to total AP transactions that were not excluded for purchase card use.

FIG. 12 depicts the GUI screen 138 with the recurring tasks mode key 146 and reports and charts link 182 selected as in FIG. 11, but further with a top potential vendors report 188 depicted in the sub-page frame 164. In particular, the total dollar amount of transactions and number of transactions are depicted of applicable procurement actions that could have been performed with a purchase account, with the corresponding missed savings tabulated.

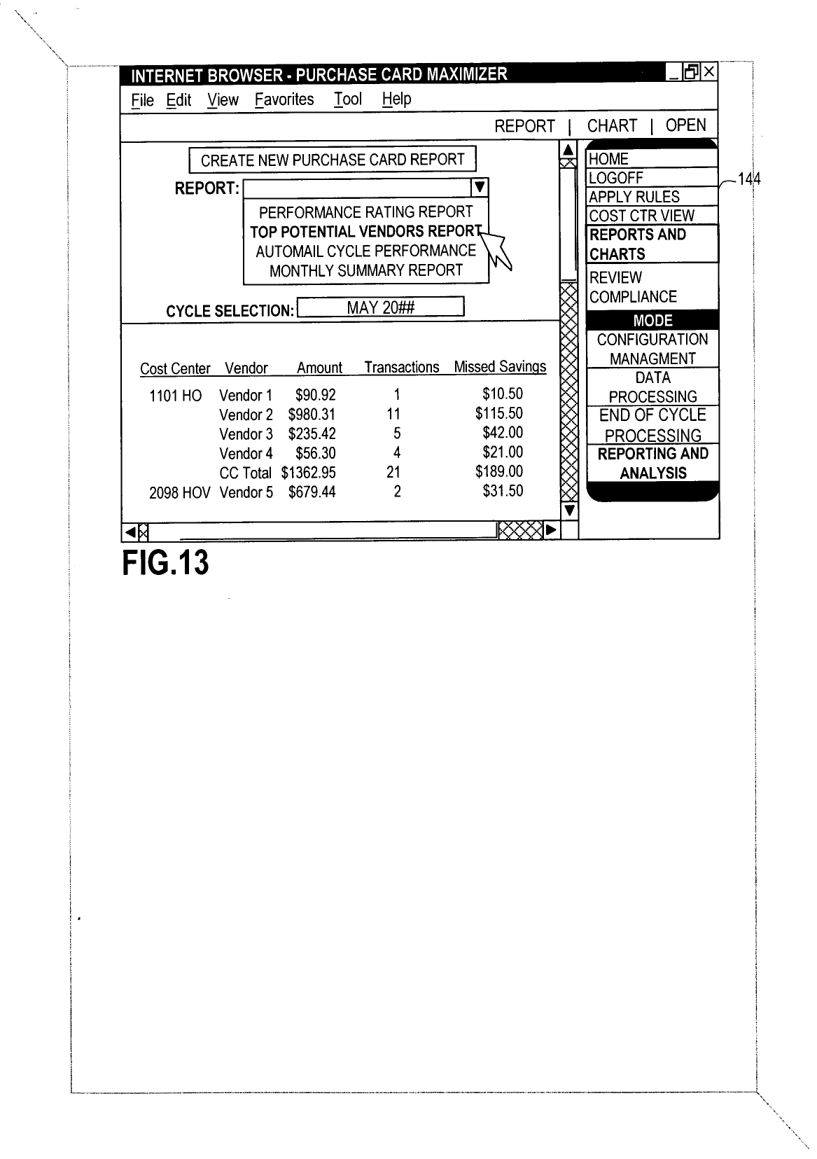

FIG. 13 depicts the GUI screen 138 with the End-of-Cycle Processing mode key 148 selected, which in turn displays sub-page selections of the home link 152, logoff link 154, a cost center view link 198, a log receipts link 200, an audit results link 202, an audit results link 204, a calculate cycle compliance link 206, a reports and charts link 206, and a review compliance link 208. Selecting the audit results link 202 results in an “enter audit results” table 210 on the sub-page frame 164. This table 210 allows selecting a portion of the cardholders for auditing. In response to selecting a subgroup (e.g., last name beginning with “A”) and a cycle (e.g., January 2002), a listing of cardholder names, the dollar amount of their procurements, number of transactions, and count of total possible points achievable for these transactions (e.g., 2 per transaction). The customer reviews the file, inserting the number of receipts received and the number of transactions for which the tax was entered correctly. If correct in both instances for each transaction, then the total amount of points is achieved, with the percentage thereof calculated. The customer also marks that the audit was performed for tracking audit compliance.

FIG. 14 depicts the GUI screen 138 with the metric calculator mode key 150 selected, which in turn displays sub-page selections of the home link 152, the logoff link 154, a rules link 212, a create metric link 214, a load metric link 216, a delete metric link 218, and a reports link 218. Selection of the latter link results in a “PCard Metric Calculator Report” 220 being displayed on the sub-page frame 164. This report tabulates the time and expense and responsible party entailed in performing each step of the transaction in either the normal procurement process of the purchase account process. In the illustrative depiction, the categories and specific steps are as follows:

2. Perform Initial Data Load

Load List of Valid GL Codes

Load GL Data for Cycle

Load purchase card Transaction Data for Cycle

3. Set Exclusions for Cycle

Exclude Vendors that do not apply to purchase card Transactions

Exclude Cost Centers that are not participating in the purchase card program for this cycle

4. Calculate Cycle Results

Calculate purchase card performance for the cycle

Vendors that have been excluded are not included in the results

Cost centers that have been excluded area calculated, but will not be included at reporting or charting time

5. Manage Cost Center

Set cost center hierarchical display

Add new cost center to the cost center hierarchy

Edit cost center

6. Provide the tools to analyze purchase card program performance

Measure and display cost center performance for the cycle by analyzing applicable purchases through a cost center hierarchy

Compare two different cycles performance

Provide reports to highlight areas in need of improvement

7. Provide the tools to analyze Cardholder's activity

Display cardholders for the cycle by auditing current cardholders activity through a cost center hierarchy

Display filtered Cardholder list in order to obtain Logged/Non-Logged Receipts information.

Edit Configuration Parameters

Audit Percent Per Cycle

Audit Score Count

Audit Score Labels

Cardholder Audit Tree Level

Legend Descriptions

Mandatory Audit Cycle

Maximum Cycles Without Audit

Metric Dollar Limit

Metric Low Limit

Metric Warning Limit

In use, non-purchase card transaction data 16 and purchase card transaction data 14 are analyzed by a purchase card maximizer 10 for an organization, which includes excluding vendors and/or cost centers that are not applicable for purchase account use (e.g., referencing control/selection data 18). Opportunities are identified by cost center for cost savings that could be realized through increased use of a purchase account. By virtue of the foregoing, the interests of the organization are furthered by hierarchically analyzing purchase account usage for the organization.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

What is claimed is:

1. A method for analyzing purchase account transactions of an organization having a plurality of account holders authorized to perform purchase account transactions and traditional procurement transactions, the organization also having an accounting system for procurement transactions, the method comprising:
determining a value of traditional procurement transactions;
determining a value of purchase account transactions; and
calculating a performance measure based on the values of the traditional procurement transactions and purchase account transactions.

2. The method of claim 1, further comprising:
receiving a plurality of purchase account transactions from a third party;
receiving a plurality of traditional procurement transactions from the accounting system; and
associating the purchase account transactions and traditional procurement transactions with the plurality of account holders.

3. The method of claim 2, further comprising:
associating each of the plurality of account holders with a hierarchical representation of the organization; and
calculating the performance measure for the hierarchical representation of the organization.

4. The method of claim 3, further comprising:
adding a plurality of cost centers to the hierarchical representation.

5. The method of claim 4, further comprising:
excluding a selected at least one of the cost centers from the calculated performance measure.

6. The method of claim 3, further comprising:
tracking auditing of purchase account transactions for account holders.

7. The method of claim 3, further comprising:
displaying a usage measure based on the hierarchical representation.

8. The method of claim 7, wherein displaying the usage measure further comprises comparing the usage measure to a target threshold.

9. The method of claim 1, further comprising:
receiving a plurality of general ledger codes assigned to the procurement transactions; and
excluding transactions associated with at least one of the plurality of general ledger codes.

10. The method of claim 1, further comprising:
adding a cost center to the hierarchical representation.

11. A method for analyzing purchase account transactions of an organization having a plurality of account holders authorized to perform purchase account transactions and traditional procurement transactions, the organization also having an accounting system for procurement transactions, the method comprising:
establishing a plurality account holder records;
creating a hierarchical representation of cost centers;
associating each of the plurality of account holder records to a respective cost center;
receiving purchase account transactions for the plurality of account holders;
receiving traditional procurement transactions for the plurality of account holders; and
calculating a performance measure for each cost center based on the assigned values of the traditional procurement transactions and purchase account transactions.

12. The method of claim 11, further comprising:
receiving a listing of general ledger codes;
designating a selected subset of the listing of general ledger codes as applicable for purchase account analysis;
receiving a respective general ledger code for each received purchase account transaction and each traditional procurement transaction; and
calculating the performance measure based on transactions having the selected subset of the listing of applicable general ledger codes.

13. The method of claim 11, wherein calculating the performance measure further comprises:
designating an exclusion class consisting of at least one vendor; and
excluding transactions associated with the exclusion class from the calculated performance measure.

14. The method of claim 11, wherein calculating the performance measure further comprises:
designating an exclusion class consisting of at least one cost center; and
excluding transactions associated with the exclusion class from the calculated performance measure.

15. An apparatus for analyzing purchase account transactions of an organization having a plurality of account holders authorized to perform purchase account transactions and traditional procurement transactions, comprising:
(a) a memory; and
(b) a program resident in the memory, the program configured to determine a value of traditional procurement transactions, to determine a value of purchase account transactions; and to calculate a performance measure based on the values of the traditional procurement transactions and purchase account transactions.

16. The apparatus of claim 15, wherein the program is further configured to receive a plurality of purchase account transactions from a third party, to receive a plurality of traditional procurement transactions maintained by the organization; and to associate the purchase account transactions and traditional procurement transactions with the plurality of account holders.

17. The apparatus of claim 16, wherein the program is further configured to associate each of the plurality of account holders with one of a selected plurality of cost centers of the organization; and to calculate the performance measure for the hierarchical representation of the organization.

18. The apparatus of claim 17, wherein the program is further configured to perform at least one of a group of functions consisting of:
(a) to relate the plurality of cost centers in an hierarchical representation;
(b) to exclude a selected at least one of the cost centers from the calculated performance measure;
(c) to track auditing of purchase account transactions for account holders; and
(d) to exclude transactions associated with at least one of the plurality of general ledger codes.

19. The system of claim 17, wherein the program is further configured to compare the performance measure for a selected cost center to a target threshold and to display results of the comparison.

20. A program product, comprising:
(a) a program configured to determine a value of traditional procurement transactions, to determine a value of purchase account transactions; and to calculate a performance measure based on the values of the traditional procurement transactions and purchase account transactions; and
(b) a signal bearing medium bearing the program.

21. The program product of claim 20, wherein the signal bearing medium includes at least one of a recordable medium and a transmission medium.
